(19) United States
(12) Patent Application Publication
(10) Pub. No.: US 2023/0271541 A1
(43) Pub. Date: Aug. 31, 2023

(54) Apparatus for Moving a Container on a Vehicle

(71) Applicant: Pierre Lavoie, Saguenay (CA)

(72) Inventor: Pierre Lavoie, Saguenay (CA)

(21) Appl. No.: 18/009,044

(22) PCT Filed: Mar. 16, 2021
(86) PCT No.: PCT/CA2021/050347

§ 371 Date: Dec. 8, 2022

Related U.S. Application Data
(60) Provisional application No. 63/037,678, filed on Jun. 11, 2020.

(51) Int. Cl. B60P 1/48

(52) U.S. Cl. CPC B60P 1/483

(57) ABSTRACT

Described is an apparatus for moving a container between two positions on a vehicle carrying bed. The apparatus includes a connector that extends away from the container and a container mover, which has a connector end and a vehicle connector end. The connector end is rotatably connected to the connector to permit the container to swing about a connector axis. The vehicle connector end is connected to the vehicle carrying bed to move about a hinge, to allow the container to be actuated to move between the two positions along an arc.

### TECHNICAL FIELD

The present generally concerns vehicles, and more particularly to modified vehicles such as flatbed trucks for carrying and moving a storage container.

### BACKGROUND

Certain vehicles such as flat-bed trucks are well-known and widely used for transporting heavy and unwieldly items such as storage boxes containing tools and the like. Generally speaking, such boxes are the mainstay of construction workers who need to transport their tools to and from a construction site every day. Flatbed trucks are practical because the flatbed area is generally sufficiently large to accommodate the storage box and other items such as ladders and construction materials. The storage box is typically stored at the rear of the flatbed adjacent the driver's cabin. The storage boxes are either permanently fixed to the flatbed or are separate and thus must be loaded onto the truck when needed. If the storage box is loaded onto the flatbed, it must be filled with the tools and then moved towards the cabin where it is secured or filled after it is secured. Either way, the manipulation of the storage box can be problematic. Furthermore, if the box is not sufficiently secured, it can shift during transportation. Moreover, in the event the truck is involved in an automobile accident, the risk the storage box will be thrown off the flatbed is high.

Once the driver arrives at the work destination, the problem is one of accessing the tools in the box. In the case where the box is secured to the flatbed, the problem is the user must climb onto the flatbed to access and then remove the contents. In a confined space such as the flatbed, this can be difficult. If the box is temporarily secured, the best way to access the items stored therein would be to man-handle the box from the rear of the flatbed to the hinged tailgate at back of the truck. Before the box can be accessed, the tailgate must be opened to provide an extension to the flatbed so that the user can access the contents of the box. If the box has shifted during transportation the user must first align the box opening with the tailgate to make access easier. Clearly, this can cause injuries to the back and extremities such as the feet and the hands. Also, even if the box remains in-line with the tailgate, there may be times when the container is too heavy for one person to move it. Similarly, if the user is already injured, repeated movement of the box may cause more injury. In addition to, or separate from injury to the person, repeated moving of the box can damage the flatbed floor.

To address these problems, a number of innovators have created designs some of which are exemplified below.
U.S. Pat. No. 4,531,774, issued on Jul. 30, 1985 to Whatley for “Truck Tool Box Anchor Assembly”;
U.S. Pat. No. 4,936,624, issued on Jun. 26, 1990 to West for “Tool Box Assembly”;
U.S. Pat. No. 5,518,158, issued on May 21, 1996 to Matlack for “Pickup Truck Tailgate Toolbox Assembly”;
U.S. Pat. No. 6,571,949, issued on Jun. 3, 2003 to Burrus IV for “Power Toolbox”;
U.S. Pat. No. 7,052,067, issued on May 30, 2006 to Walker for “Combination Bed-Liner And Toolbox for Pick-Up Truck”;
U.S. Pat. No. 8,393,665, issued on Mar. 12, 2013 to Villano for “Pick-Up truck bed Tool Box System”;
U.S. Pat. No. 8,544,708 issued on Oct. 1, 2013 to Malmin for “Folding Pick-Up Truck Tool Box”;
U.S. Pat. No. 8,757,458 issued on Jun. 24, 2014 to Nebel for “Storage Box with Slide Out Storage Tray”;
U.S. Pat. No. 8,857,684 issued on Oct. 14, 2014 to Slide Out Associates for “Slide-Out Truck Tool Box”;
U.S. Pat. No. 9,308,947 issued on Apr. 12, 2016 to JAC Products Inc. for “Vehicle tailgate with Built In Stowage Compartment”;
U.S. Pat. No. 9,783,129 issued on Oct. 10, 2017 to Roach for “Automotive Storage Container”;
U.S. Pat. No. 9,308,947 issued on Apr. 12, 2016 to JAC Products Inc. for “Vehicle tailgate with Built In Stowage Compartment”;
Published United States patent application number US2005/0121931 to Waye for “Quick Release Assembly for Securing a Tool Box to a Pickup Bed”;
Published United States patent application number US2006/0266778 to Allotey for “Collapsible Tool/Utility Box”; and
Published United States patent application number US2010/0264180 to Allotey for “Collapsible Tool/Utility Box”.

While many of the aforesaid designs are useful in addressing some of the problems, they generally do so by allowing easy access to a modified box which remains secured to the flatbed. Also, a number of designs while ingenious would likely be prohibitively expensive and would require a re-design of, for example, the tailgate to store the tools. A number of designs shown provide largely impractical re-designs of the storage box to make them easier to fill and remove. In one case, the design requires a collapsing storage box, which would likely have minimal use.

Thus, there is a clear unmet need for storage box apparatus that can be used with a flatbed truck that allows easy storage, transportation and unloading at a destination.

### BRIEF SUMMARY

The inventor has addressed the aforesaid problems by developing a new and unobvious apparatus which permits a storage container such as a heavy tool box with an access door to be moved up and over a cargo hold (carrying area or flatbed) of the truck and depositing the container at the rear of the flatbed with the access door facing towards the user. Advantageously, this allows for easy access to the interior of the container without having to unload the container itself or to have the user climb onto the flatbed and open the door in a confined space. Moreover, most flatbed trucks have a tailgate which opens down to extend the carrying floor area. A novel and unobvious design of a drive wheel and arm mechanism allows the container to move in an arcuate pathway up and over the carrying area to place the container on the tailgate with the access door accessible at waist height. The use of arms with a combined hinge and rotation attachment allows a user to lift and move a container from one location to another, preferably the tailgate, with ease and without interfering with other materials loaded on the flatbed.

Accordingly, in one embodiment there is provided an apparatus for moving a container between first and second positions on a vehicle carrying bed, the apparatus comprising:
a connector member extending away from the container; and
a container moving member having a first connector member end and a first vehicle connector end, the first connector member end being rotatably connected to the connector member to permit the container to swing about a connector member axis, the first vehicle connector end being connected to the vehicle carrying bed for movement about a hinge to allow the container to be actuated to move between the first position and the second position along an arcuate pathway.

In one example, the container includes first and second container sidewalls, the first container sidewall having a first connector member, the second container sidewall having a second connector member, both connector members extending away from the respective container sidewall. The connector member axis extends through the first and second connector member. The container moving member includes first and second arms, the first arm having a first container connector end and a first vehicle connector end, the second arm having a second container connector end and a second vehicle connector end, the container connector ends being rotatably connected to the first and second connector ends so that, when actuated, the container swings about the connector member axis, The first and the second vehicle connector ends are hingeably connected to the vehicle carrying bed so that the container is actuatable to move between the first position and the second position along the arcuate pathway.

In one example, an actuator is connected to the first and second arms to drive the first and the second arms about the arcuate pathway so as to move the container from the first location adjacent a vehicle cabin to the second location at a carrying area tailgate. The actuator drives the arms about the arcuate pathway so as to move the container from the second location at the carrying area tailgate to the first location adjacent a vehicle cabin. The actuator includes a prime mover operably connected to the first and second arms. The prime mover is a 12 volt electric motor. The prime mover is a heavy-duty hydraulic cylinder.

In one example, the container access face includes a door located to access the container interior.

In another example, a protective cover is hingeably connected to a carrying area sidewall.

In another example, a protective cover is attached to a carrying area sidewall, the protective cover being a rollable tarpaulin.

In one example, the actuator is connected to the first vehicle connector end of the first arm, the actuator including i) a drive wheel fixably mounted on a carrying area sidewall to drive the first arm about the arcuate pathway so as to move the container between the first and second locations; and ii) a driven wheel rotatably connected to the first arm, the driven wheel being meshingly engaged with the drive wheel so that the prime mover moves the container along the arcuate pathway. The actuator includes a drive chain in communication with the drive wheel and the driven wheel, the drive chain being connected to a motor fixably mounted on the flatbed floor. The drive wheel and the driven wheel each include a plurality of circumferentially disposed teeth which meshingly engage each other to drive the arm about the arcuate pathway. The drive wheel has a circumference larger than the driven wheel circumference, the circumference of the drive wheel being of sufficient size to permit movement of the container between the first and second locations without contacting the flatbed.

In one example, the first and second arms each have lengths that are extendable.

In one example, the first and second vehicle connector ends are connected together at the hinge.

In one example, the first and second arms each include an arm hinge located between the container connector end and the vehicle connector end.

In another example, the actuator is connected a plate that is fixably connected to the tailgate floor, the first and second arms each having a first center of hinge rotation and a first center of prime mover rotation for driving the first and the second arms about the arcuate pathway.

In one example, the container moving member includes a quick release mechanism.

In another example, the arm includes first and second arm portions hingeably connected at the hinge portion, the arm having a lock pin is disposed way from the hinge portion towards the second end so as to lock the arm in a linear fashion once the container is moved from the area to the tailgate.

Accordingly, in another embodiment there is provided an apparatus for moving a container between a rear portion of a flatbed to a tailgate portion on a flatbed truck, the apparatus comprising:
a first connector member extending from a first container sidewall and a second connector member extending from a second container sidewall, and a connector member axis extending through the first and second connector members; and
first and second arms, the first arm having a first container connector end and a first vehicle connector end, the second arm having a second container connector end and a second vehicle connector end, the container connector ends being rotatably connected to the first and second connector ends so that, when actuated, the container swings about the connector member axis, the first and the second vehicle connector ends being hingeably connected to the flatbed so that the container is actuatable to move between the rear portion and the tailgate portion along an arcuate pathway.

Accordingly in another embodiment, there is provided a storage container for use with a flatbed truck, the storage container comprising;
first and second upstanding sidewalls;
an access roof interconnecting the upstanding sidewalls;
an access portion having an opening for accessing the interior of the container, the access portion being located between the first and second upstanding sidewalls; and
first and second mounting rods connected to the respective first and second upstanding sidewalls, the mounting rods being sized and shaped to rotatably mount thereon first and second arms, the mounting rods extending orthogonally away from the respective upstanding sidewalls, the first and second arms being hingeably connected to first and second flatbed sidewalls so that the container is actuatable to swingingly move between the rear portion and the tailgate portion along an arcuate pathway.

In one example, the storage container is a generally rectangular shaped box.

### BRIEF DESCRIPTION OF THE DRAWINGS

These and other features of that described herein will become more apparent from the following description in which reference is made to the appended drawings wherein:

FIG. 1 is a perspective view of an embodiment of top view of a flatbed truck showing an alternative embodiment of storage container moving mechanism;

FIG. 2 is a side view showing the movement of the storage container along an arcuate pathway;

FIG. 2A is a perspective view of a storage container showing an axis of rotation;

FIG. 3 is a side detailed view of the drive mechanism of FIG. 1;

FIG. 4 is a perspective view of the storage container;

FIG. 5 is a side detailed view of another embodiment of a flatbed truck showing another storage container moving mechanism.

FIG. 6 is a side view of an embodiment of a flatbed truck showing a storage container moving apparatus;

FIG. 7 is a schematic diagram showing an arcuate pathway along which the storage container moves;

FIG. 8 is a close up, detailed view of a drive wheel and a driven wheel with a chain and actuator; and

FIG. 9 is a side view of an alternative storage container moving mechanism;

### DETAILED DESCRIPTION

### Definitions

Unless otherwise specified, the following definitions apply: The singular forms “a”, “an” and “the” include corresponding plural references unless the context clearly dictates otherwise.

As used herein, the term “comprising” is intended to mean that the list of elements following the word “comprising” are required or mandatory but that other elements are optional and may or may not be present.

As used herein, the term “consisting of” is intended to mean including and limited to whatever follows the phrase “consisting of”. Thus, the phrase “consisting of” indicates that the listed elements are required or mandatory and that no other elements may be present.

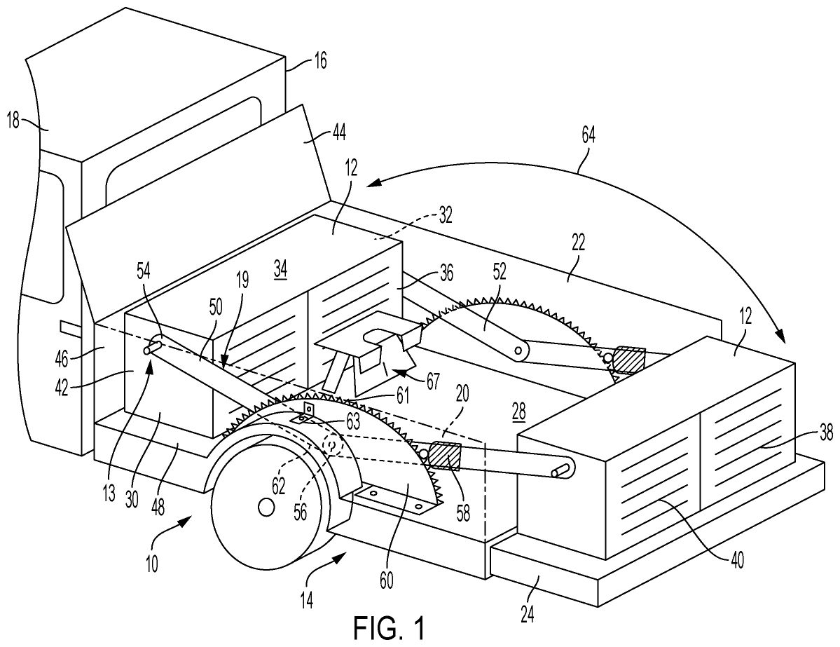

Referring now to FIG. 1, there is shown generally at 10 an embodiment of an apparatus for moving a storage container 12 between two locations on a vehicle flatbed 14. It should be noted that the terms “flatbed” and “carrying area” are used interchangeably throughout and are intended to mean a defined zone on which materials are stored for transportation. In general terms, the “carrying area” can be defined as a cargo bay of a vehicle. The vehicle flatbed 14 is part of a flatbed truck 16 which includes a cabin 18, two flatbed sidewalls 20, 22 and a tailgate 24 that is hingeably connected to a flatbed floor 28. When open, the tailgate 24 extends the flatbed floor 28 away from the flatbed 14 and provides a user easy access to the flatbed 14. Furthermore, the tailgate 24, when open, is generally disposed at around waist height so that any materials loaded on the flatbed 14 can be easily and safely unloaded or unloaded.

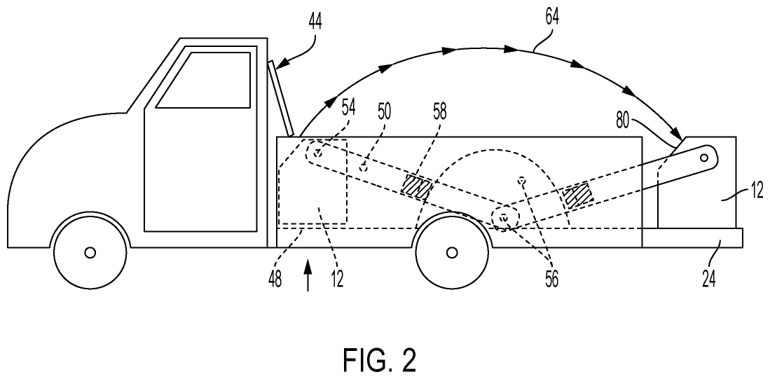

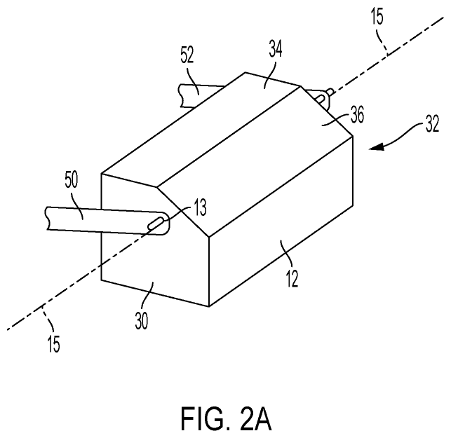

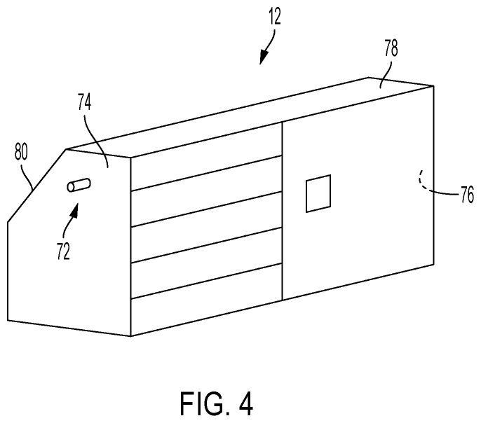

Referring to FIGS. 2A and 4, the storage container 12 is typically a rectangular box which has first and second sidewalls 30,32 a top wall 34, and an access portion 36. The access portion 36 generally includes a door 38 and drawers 40. If desired, the top wall 34 can be hingeably connected to a rear wall 42 of the container 12 to allow the user to fill the container 12 from above. The design of the storage container 12 depends on its intended use and its selection depends largely on the flatbed 14 size and the load to be carried. Importantly though for this design, the orientation of the access portion 36 is such that it is disposed away from the vehicle cabin 18 towards the tailgate 24, the importance of which will be described below. To protect the storage container 12 from physical damage or from exposure to the weather, a protective cover 44 can be connected to a rear flatbed sidewall 46. The protective cover 44 can be a solid panel, in which case it is hinged to the flatbed 14 or a sheet of rollable material such as canvas tarpaulin, the selection of which depends on the intended use and the environment in which the truck is used. Depending on the needs of the user, the storage container 12 may have many uses and designs. For example, a chest for storing hunting and fishing gear; the container 12 may include a number of drawers, divided compartments, shelves and the like. Also, even though a flatbed truck is used throughout as an example of a vehicle on which the apparatus is used, the person of ordinary skill in the art will recognize that any vehicle having a flatbed are can be used. The term “flatbed”, as used herein, is intended to mean an area of a vehicle having a floor, sidewalls and a tailgate, or some other means by which the container can be deposited thereon during movement of the container. Such vehicles may include, for example, small transport vans, promasters or various cargo vans and the like. Any vehicle whether wheeled or not can be used provided there is sufficient clearance to allow the container to move along the arcuate pathway, as described below.

As best seen in FIGS. 1, 2A and 4, the storage container 12, in a default transportation configuration, is located in an area of the flatbed 48 that is adjacent the cabin 18. The default configuration, of first position, permits safe transportation of the storage container 12 to a work site. During transportation, the tailgate 24 is closed in an upright position that is about 90 degrees to the flatbed floor 28. The apparatus 10 includes a connector member 13 that extends away from the container 12 and includes a connector member axis 15 about which the container 12 can rotatably move in a swinging manner. Broadly speaking, the apparatus 10 includes a container moving member 19 that includes two arms 50, 52. For the sake of brevity and clarity, and because each arm is structurally identical, only one will be described in detail. Nevertheless, a person of ordinary skill in the art will readily recognize that although a single arm will work to move the container 12, both arms 50,52 would be necessary to operate the apparatus 10 in an optimal manner. The arm 50 has a first container connector end 54, which is rotatably connected to the container sidewall 30, and a second vehicle connector end 56, which is hingeably connected to the flatbed sidewall 20. The arm 50 is an elongate piece of material that is sized, shaped and of sufficient strength to lift and carry the storage container during operation of the apparatus 10.

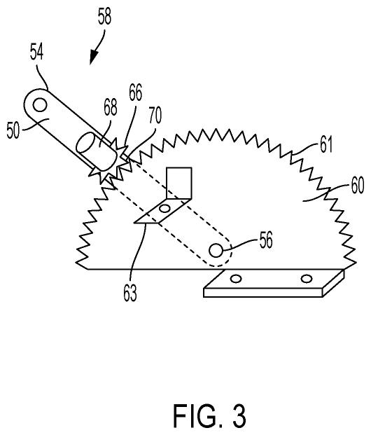

As best seen in FIGS. 2 and 3, an actuator 58 is connected to the arm 50 between the first and second ends 54, 56. A first semi-circular drive wheel 60 is fixably mounted on the flatbed sidewall 30. The semi-circular drive wheel has a plurality of teeth that are circumferentially disposed about the drive wheel 60 are disposed to faced inwardly towards the flatbed. The drive wheel 60 is bolted to the flatbed floor and is typically located adjacent a wheel arch 62. Also included is an L-shaped connector 63 that is bolted to the backside of the drive wheel 60 and further connects it to the wheel arch 62. Generally speaking, the actuator 58 is in communication with the drive wheel 60 to drive the arm 50 about an arcuate pathway 64. In operation, the actuator 58 moves the container 12 from the default configuration where the container is stored in the area of the flatbed 48 to the tailgate 24, which is the second location. As the container 12 moves along the arcuate pathway 64, it rotates about the first end of the arm so that the access remains disposed (or facing) the tailgate, aided by the hinge at the second end. Thus, at the end of its arcuate journey, the container is deposited onto the tailgate with the access facing the user thereby allowing easy access to its contents.

Turning now to FIG. 3, the actuator 58 includes a second drive wheel 66 and a prime mover 68. The actuator 58 is located approximately half way along the arm 50. In one example, the prime mover 68 is typically a 2-volt to 12-volt electric motor with sufficient power to drive the container 12 along the pathway 64. One skilled in the art will readily recognize that other prime movers are available that would work equally as well and would be selected based on the needs of the user. The prime mover 68 is operably connected to the second drive wheel 66 to rotate it. The second drive wheel 66 includes a plurality of teeth 70 circumferentially disposed so that they meshingly engage the teeth on the first fixed drive wheel. The prime mover 68, when selected to move the container 12 from the default configuration causes the second drive wheel to move along the semi-circle of the first drive wheel thereby moving the arm 50 along the arcuate pathway 64. Once the container 12 reaches the tailgate, the prime mover disengages. To move the container back to the default configuration, the user merely selects the motor to move in reverse and the container moves along a reverse arcuate pathway back to the default configuration.

Referring now to FIG. 4, the storage container 12 also includes two extensions rods 72 that are disposed outwardly from container upstanding sidewalls 74, 76. A roof 78 is also located to interconnect the sidewalls 74, 76. The first end of the arm slides over the extensions 72 to permit mounting of the first arm end to rotate thereabout, in essence causing the container 12 to swing as it moves along the arcuate pathway 64. The container 12 is generally a rectangular shaped box, typically made from aluminum and may include a door with drawers. While throughout the description, construction tools have been referred to. A person of ordinary skill in the art will readily recognize that the container may be used to store items such as groceries and the like.

Referring to FIGS. 2 and 4, the storage container 12 may also include a slanted wall 80. The slanted (or inclined) wall 80 is located so that in the event the user wishes to use the protective cover 44, the slanted wall 80 provides sufficient clearance between the storage container 12 and the cover 44 during its movement along the arcuate pathway 64.

Referring back to FIG. 1, a so-called fifth wheel hitch 67 allows a trailer or caravan (not shown) to be hitched to the flatbed truck for pulling. The hitch 67 is located on the flatbed floor 28 and disposed a sufficient distance away from the container 12 to permit access thereto while the trailer is still connected to the hitch. Without the current apparatus, the user would have to disconnect the trailer from the hitch, remove it so as to have access to the container 12. With the new apparatus, the user would merely move the container 12 along the arcuate pathway 64 to provide access to the container 12.

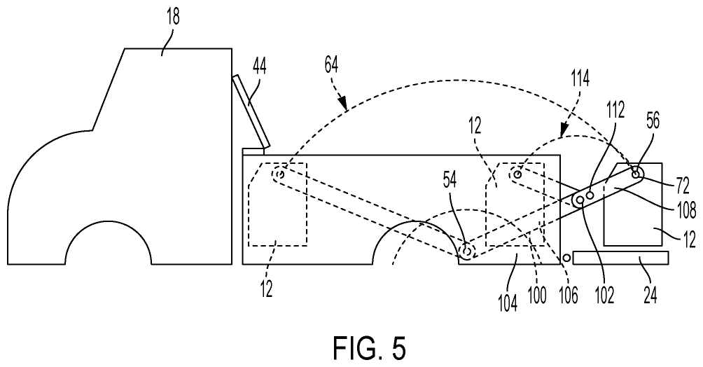

According to an alternative embodiment, and referring now specifically to FIG. 5, an arm 100 include a second hinge portion 102 located between the arm's second end 56 and the first end 54, which, as described above, is rotatably connected to the container sidewall 30. The second end 56 remains hingeably connected to the flatbed sidewall 20. Generally speaking, in the alternative embodiment, the container 12 is still able to move along the arcuate pathway 64 to move the container 12 between the locations 24 and 48. In an example where the container 12 is located in an area 104 adjacent the tailgate 24, and the user desires that the container be moved to the tailgate 24, the alternative embodiment was designed to do this. The arm 100 includes first and second arm portions 106, 108 hingeably connected at the hinge portion 102. A lock pin 112 is disposed way from the hinge portion towards the second end 56 to lock the arm 100 in a linear fashion once the container is moved from the area 104 to the tailgate 24. In operation, the arm 100 is mechanically moved along a second arcuate pathway 114 from the area 104 to the tailgate 24 as the second end 56 rotates about the extensions 72. As discussed above, for the sake of brevity only one arm 100 is described. When desired, the container 12 can then be mechanically moved from the tailgate 24 back to the area 104 in a reverse movement along the second arcuate pathway 114, after which the tailgate 24 can be closed. As described above, the access portion 36 of the container 12 always remains facing away from the cabin 18. This embodiment is particularly useful for loading and unloading of groceries at a grocery store.

Referring now to FIGS. 2A, 4, 6, 7, 8, and 9, two additional alternative embodiments are illustrated at 200 and 300 respectively. Both embodiments 200, and 300 include a connector member 202 that extends away from the container 12 and a container moving member 204 that includes a first connector member end 206 and a first vehicle connector end 208. The first connector member end 206 is rotatably connected to the connector member 202 to permit the container 12 to swing about the connector member axis 15. As with the previous embodiments described above, the first vehicle connector end 208 is connected to the vehicle carrying bed for movement about the hinge to allow the container 12 to be actuated to move between the first position and the second position along the arcuate pathway 64.

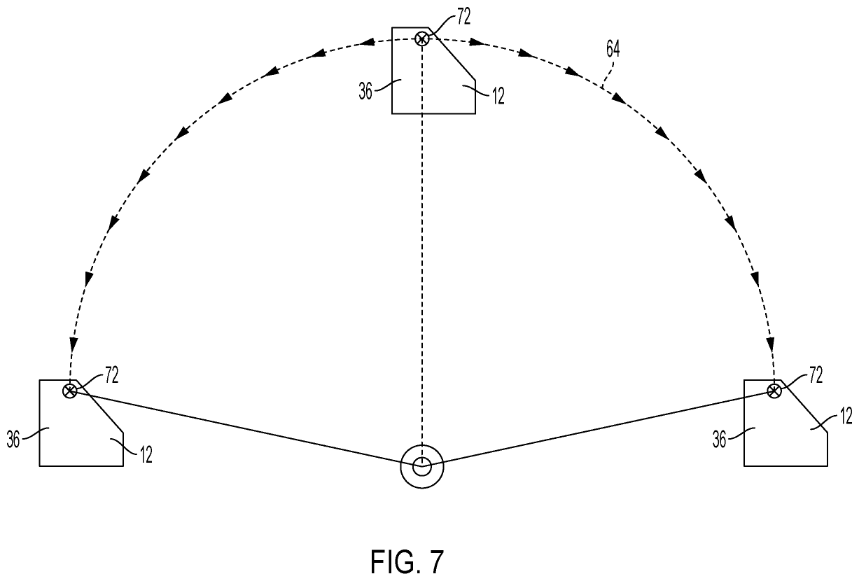

As best illustrated in FIG. 7, the container 12 moves along the arcuate pathway 64 such that the face 36 always remains facing in the same direction. In essence, the axial rotation of the container 12 about the container extensions 72, 76 causes the container to advantageously move in a swinging manner by gravitational forces during its movement along the arcuate pathway.

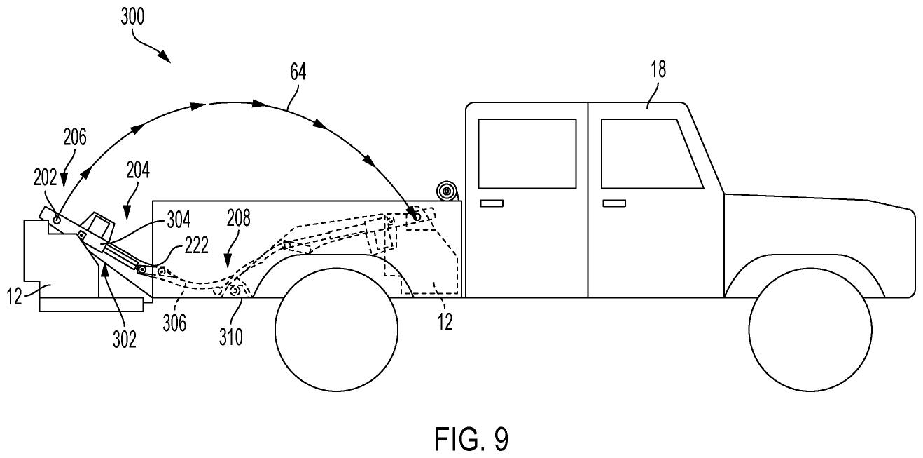

Referring to FIG. 9, the actuator 302 includes a prime mover 304 is operably connected to first and second arms 306, 308. In one example, the prime mover is a 12 volt electric motor. In another example, the prime mover is a heavy-duty hydraulic cylinder.

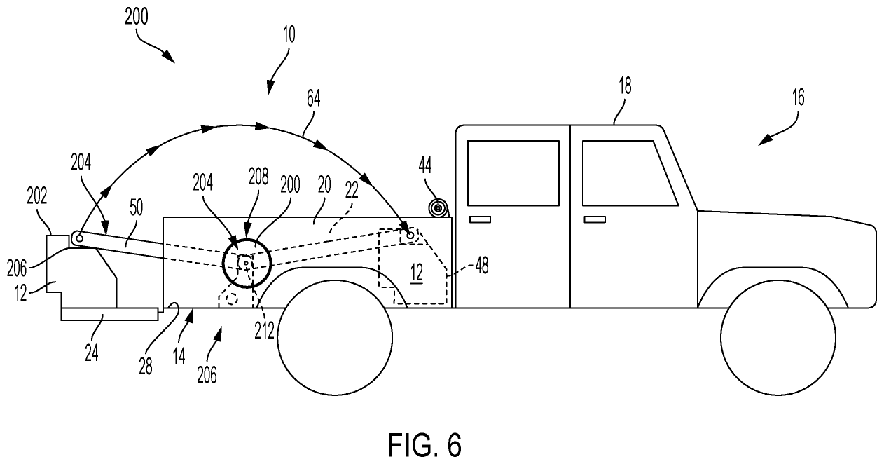

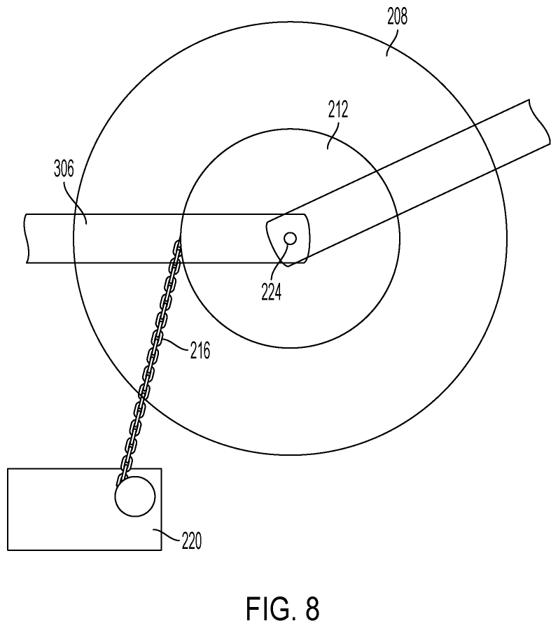

Referring now specifically to FIGS. 6 and 8, the desirable embodiment 200 includes a gear system 204 as part of an actuator 206. The actuator 206 is includes a drive wheel 208 that is fixably mounted on a carrying area sidewall 210 to drive the first arm 306 about the arcuate pathway 64 so as to move the container 12 between the first and second locations. A driven wheel 212 is rotatably connected to the first arm 306 so that the driven wheel 212 meshingly engages with the drive wheel 212 so that the prime mover moves the container 12 along the arcuate pathway 64. The actuator 206 includes a drive chain 216 in communication with the drive wheel 208 and the driven wheel 212. The drive chain 216 is connected to a motor 220 that fixably mounted on the flatbed floor. The drive wheel 208 and the driven wheel 212, like the drive wheels described above, each include a plurality of circumferentially disposed teeth which meshingly engage each other to drive the arm about the arcuate pathway 64. The drive wheel 208 has a circumference larger than the driven wheel 212 circumference. The circumference of the drive wheel 208 is of sufficient size to permit movement of the container 12 between the first and second locations without contacting the flatbed. The arms are constructed from, for example, aluminum, and each have lengths that are extendable to accommodate different truck sizes or loads to be carried. The first and second vehicle connector ends are connected together at the hinge 224 to allow the two arms to move thereabout, while maintaining the container 12 in the arcuate pathway movement. The first and second arms each include an arm hinge 222 located between the container connector end and the vehicle connector end.

In the example shown in FIG. 9, the actuator is connected a plate 310 that is fixably connected to the tailgate floor. The first and second arms both a first center of hinge rotation 312 and a first center of prime mover 314 rotation for driving the first and the second arms about the arcuate pathway. For ease of loading and unloading, the container moving member includes a quick release mechanism.

### OTHER EMBODIMENTS

From the foregoing description, it will be apparent to one of ordinary skill in the art that variations and modifications may be made to the embodiments described herein to adapt it to various usages and conditions.

What is claimed is:

1. An apparatus for moving a container between first and second positions on a vehicle carrying bed, the apparatus comprising:
a connector member extending away from the container; and
a container moving member having a first connector member end and a first vehicle connector end, the first connector member end being rotatably connected to the connector member to permit the container to swing about a connector member axis, the first vehicle connector end being connected to the vehicle carrying bed for movement about a hinge to allow the container to be actuated to move between the first position and the second position along an arcuate pathway.

2. The apparatus, according to claim 1, in which the container includes first and second container sidewalls, the first container sidewall having a first connector member, the second container sidewall having a second connector member, both connector members extending away from the respective container sidewall.

3. The apparatus, according to claim 2, in which the connector member axis extends through the first and second connector members

4. The apparatus, according to claim 3, in which the container moving member includes first and second arms, the first arm having a first container connector end and a first vehicle connector end, the second arm having a second container connector end and a second vehicle connector end, the container connector ends being rotatably connected to the first and second connector ends so that, when actuated, the container swings about the connector member axis,

5. The apparatus, according to claim 4, in which the first and the second vehicle connector ends are hingeably connected to the vehicle carrying bed so that the container is actuatable to move between the first position and the second position along the arcuate pathway.

6. The apparatus, according to claim 4, in which an actuator is connected to the first and second arms to drive the first and the second arms about the arcuate pathway so as to move the container from the first location adjacent a vehicle cabin to the second location at a carrying area tailgate.

7. The apparatus, according to claim 6, in which the actuator drives the arms about the arcuate pathway so as to move the container from the second location at the carrying area tailgate to the first location adjacent a vehicle cabin.

8. The apparatus, according to claim 6, in which the actuator includes a prime mover operably connected to the first and second arms.

9. The apparatus, according to claim 8, in which the prime mover is a 12 volt electric motor.

10. The apparatus, according to claim 8, in which the prime mover is a heavy-duty hydraulic cylinder.

11. The apparatus, according to claim 1, in which the container access face includes a door located to access the container interior.

12. The apparatus, according to claim 1, in which a protective cover is hingeably connected to a carrying area sidewall.

13. The apparatus, according to claim 1, in which a protective cover is attached to a carrying area sidewall, the protective cover being a rollable tarpaulin.

14. The apparatus, according to claim 6, in which the actuator is connected to the first vehicle connector end of the first arm, the actuator including i) a drive wheel fixably mounted on a carrying area sidewall to drive the first arm about the arcuate pathway so as to move the container between the first and second locations; and ii) a driven wheel rotatably connected to the first arm, the driven wheel being meshingly engaged with the drive wheel so that the prime mover moves the container along the arcuate pathway.

15. The apparatus, according to claim 14, in which the actuator includes a drive chain in communication with the drive wheel and the driven wheel, the drive chain being connected to a motor fixably mounted on the flatbed floor.

16. The apparatus, according to claim 14, in which the drive wheel and the driven wheel each include a plurality of circumferentially disposed teeth which meshingly engage each other to drive the arm about the arcuate pathway.

17. The apparatus, according to claim 14 in which the drive wheel has a circumference larger than the driven wheel circumference, the circumference of the drive wheel being of sufficient size to permit movement of the container between the first and second locations without contacting the flatbed.

18. The apparatus, according to claim 4, in which the first and second arms each have lengths that are extendable.

19. The apparatus, according to claim 4, in which the first and second vehicle connector ends are connected together at the hinge

20. The apparatus, according to claim 4, the first and second arms each include an arm hinge located between the container connector end and the vehicle connector end.

21. The apparatus, according to claim 6, in which the actuator is connected a plate that is fixably connected to the tailgate floor, the first and second arms each having a first center of hinge rotation and a first center of prime mover rotation for driving the first and the second arms about the arcuate pathway.

22. The apparatus, according to claim 1, in which the container moving member includes a quick release mechanism.

23. The apparatus, according to claim 13, in which the arm includes first and second arm portions hingeably connected at the hinge portion, the arm having a lock pin is disposed way from the hinge portion towards the second end so as to lock the arm in a linear fashion once the container is moved from the area to the tailgate.

24. An apparatus for moving a container between a rear portion of a flatbed to a tailgate portion on a flatbed truck, the apparatus comprising:
a first connector member extending from a first container sidewall and a second connector member extending from a second container sidewall, and a connector member axis extending through the first and second connector members; and
first and second arms, the first arm having a first container connector end and a first vehicle connector end, the second arm having a second container connector end and a second vehicle connector end, the container connector ends being rotatably connected to the first and second connector ends so that, when actuated, the container swings about the connector member axis, the first and the second vehicle connector ends being hingeably connected to the flatbed so that the container is actuatable to move between the rear portion and the tailgate portion along an arcuate pathway.

25. A storage container for use with a flatbed truck, the storage container comprising;
first and second upstanding sidewalls;
an access roof interconnecting the upstanding sidewalls;
an access portion having an opening for accessing the interior of the container, the access portion being located between the first and second upstanding sidewalls; and
first and second mounting rods connected to the respective first and second upstanding sidewalls, the mounting rods being sized and shaped to rotatably mount thereon first and second arms, the mounting rods extending orthogonally away from the respective upstanding sidewalls, the first and second arms being hingeably connected to first and second flatbed sidewalls so that the container is actuatable to swingingly move between the rear portion and the tailgate portion along an arcuate pathway.

26. The storage container, according to claim 25, is a generally rectangular shaped box.
